(19) United States
(12) Patent Application Publication
(10) Pub. No.: US 2022/0326097 A1
(43) Pub. Date: Oct. 13, 2022

(54) COOLANT DETERIORATION LEVEL CALCULATION SYSTEM

(71) Applicant: TOYOTA JIDOSHA KABUSHIKI KAISHA, Toyota-shi (JP)

(72) Inventor: Hiromasa SUZUKI, Toyota-shi (JP)

(73) Assignee: TOYOTA JIDOSHA KABUSHIKI KAISHA, Toyota-shi (JP)

(21) Appl. No.: 17/655,291

(22) Filed: Mar. 17, 2022

(30) Foreign Application Priority Data
Apr. 9, 2021 (JP) 2021-066455

(51) Int. Cl. G01K 13/02

(52) U.S. Cl. CPC G01K 13/026

(57) ABSTRACT

A CPU executes acquisition processing of acquiring a cumulative time for each temperature of a coolant, conversion processing of converting each cumulative time into a converted value which is a cumulative time at a predetermined reference temperature, and calculation processing of calculating a deterioration level of the coolant based on the sum of the converted values.

### CROSS-REFERENCE TO RELATED APPLICATION

This application claims priority to Japanese Patent Application No.

2021-066455 filed on Apr. 9, 2021, incorporated herein by reference in its entirety.

### BACKGROUND

### 1. Technical Field

The present disclosure relates to a coolant deterioration level calculation system.

### 2. Description of Related Art

Coolant of an internal combustion engine deteriorates over time. For example, a device disclosed in WO2012/107990 is designed to determine whether or not the coolant has deteriorated.

### SUMMARY

However, if a deterioration level of the coolant can be calculated instead of merely determining whether the coolant has deteriorated, it is possible to appropriately predict when the coolant should be replaced according to, for example, usage status of the internal combustion engine, which is technically beneficial.

A coolant deterioration level calculation system according to an aspect of the present disclosure calculates a deterioration level of coolant used for the internal combustion engine and includes an execution unit. The execution unit is configured to execute acquisition processing of acquiring a cumulative time for each temperature of the coolant, conversion processing of converting cumulative times into converted values, respectively, and calculation processing of calculating a deterioration level based on a sum of the converted values. The converted value is a cumulative time at a predetermined reference temperature.

The longer the cumulative time for each temperature of the coolant is, the more the coolant deteriorates. In a case where the cumulative time is the same but the coolant has a higher temperature, the coolant deteriorates more as compared with a case where the coolant has a lower temperature. When calculating the deterioration level of the coolant, it is necessary to take account of the coolant temperature and the cumulative time for each temperature. In the configuration, each cumulative time acquired for each temperature is converted into a converted value. The converted value is a cumulative time at a predetermined reference temperature. Therefore, the cumulative time for each temperature is converted into the cumulative time assuming that the coolant temperature is the reference temperature. Since the deterioration level is calculated based on the sum of the converted values, i.e. the converted cumulative times, the deterioration level is obtained considering the coolant temperature and the cumulative time for each temperature. Consequently, the deterioration level of the coolant can be calculated accurately.

Further, the lower the coolant temperature is, the less likely it is that the coolant will deteriorate. Accordingly, in the above aspect, in the acquisition processing, when a temperature of the cumulative time is lower than the reference temperature, the cumulative time may be converted such that the converted value is smaller than the cumulative time before conversion.

Further, the higher the coolant temperature is, the easier the coolant deteriorates. Accordingly, in the above aspect, in the acquisition processing, when a temperature of the cumulative time is higher than the reference temperature, the cumulative time may be converted such that the converted value is greater than the cumulative time before conversion.

In the above aspect, the execution unit may execute estimation processing of estimating a temperature change of the coolant while the execution unit has stopped operating, based on stop-time information including a temperature of the coolant at the time when the execution unit stops operating while the engine has stopped, start-time information including a temperature of the coolant at the time when the execution unit starts operating while the engine has started, and a stop time during which the execution unit has stopped operating, and update processing of updating the cumulative time for each temperature based on the estimated temperature of the coolant while the execution unit has stopped operating.

Because the coolant temperature remains high for a while even though the internal combustion engine has stopped, the coolant keeps deteriorating even while the internal combustion engine has stopped. In a case where the execution unit stops operating due to the engine stopping, the temperature change of the coolant during the stop cannot be acquired. In the above configuration, the temperature change of the coolant while the execution unit has stopped operating can be estimated by the estimation process stated above. The cumulative time for each temperature is updated based on the coolant temperature while the execution unit has stopped operating. Consequently, the deterioration level is calculated using the coolant temperature while the execution unit has stopped operating, and thus the estimation accuracy of the deterioration level is further improved.

In the above aspect, a plurality of temperature zones may be set. The cumulative time for each temperature of the coolant may be a cumulative time for each of the temperature zones, and a temperature range of the higher temperature zone may be narrower than a temperature range of the lower temperature zone.

With the above configuration, since the plurality of temperature zones are set, it is possible to reduce a calculation load of the execution unit as compared with a case where such temperature zones are not set. In such a configuration, the temperature range of the higher temperature zone is narrower than the temperature range of the lower temperature zone. Since the temperature range of the temperature zone on the high temperature side, which has a great influence on the deterioration level, is narrow, it is possible to reduce an estimation error of the deterioration level caused by dividing the temperature range.

In the above aspect, a plurality of temperature zones may be set. The cumulative time for each temperature of the coolant may be a cumulative time for each of the temperature zones, and a temperature range of the temperature zone in which the cumulative time tends to be longer may be narrower than a temperature range of the temperature zone in which the cumulative time tends to be shorter.

With the above configuration, since the plurality of temperature zones are set, it is possible to reduce a calculation load of the execution unit as compared with a case where such temperature zones are not set. In such a configuration, the temperature range of the temperature zone in which the cumulative time tends to be longer is narrower than the temperature range of the temperature zone in which the cumulative time tends to be shorter. Since the temperature range of the temperature zone in which the cumulative time tends to be longer, which has a great influence on the deterioration level, is narrow, it is possible to reduce an estimation error of the deterioration level caused by dividing the temperature range.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram illustrating a configuration of a deterioration level calculation system according to one embodiment;

FIG. 2 is a flowchart illustrating a procedure of processes executed by a control device according to the same embodiment;

FIG. 3 is a graph illustrating a temperature zone and a counter value of the same embodiment;

FIG. 4 is a flowchart illustrating a series of processes executed by the control device according to the same embodiment;

FIG. 5 is a flowchart illustrating a procedure of processes executed by a data analysis device according to the same embodiment;

FIG. 6 is a graph illustrating a temperature zone and a converted counter value of the same embodiment; and

FIG. 7 is a flowchart illustrating the series of processes executed by the data analysis device according to the same embodiment.

### DETAILED DESCRIPTION OF EMBODIMENTS

System Configuration

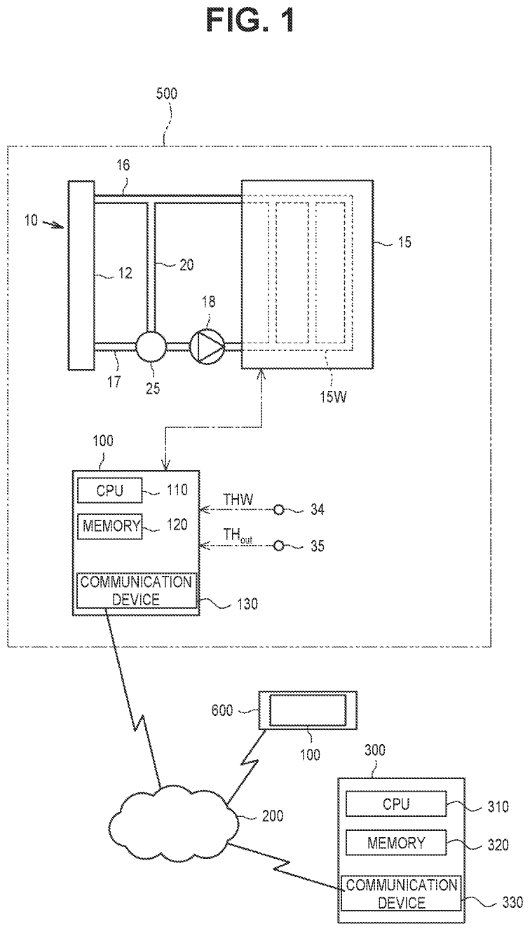

Hereinafter, one embodiment in which the coolant deterioration level calculation system is applied to an internal combustion engine mounted on a vehicle will be described with reference to FIGS. 1 to 7.

As shown in FIG. 1, a vehicle 500 includes an internal combustion engine 15, a cooling device 10, and the like. The cooling device 10 is a device that cools the internal combustion engine 15 with coolant. A rust inhibitor or the like is added to the coolant.

The cooling device 10 includes a radiator 12, which is a heat exchanger. A water jacket 15W is formed inside a cylinder block and a cylinder head of the internal combustion engine 15. A coolant outlet of the water jacket 15W and a coolant inlet of the radiator 12 are connected by a first passage 16. A coolant inlet of the water jacket 15W and a coolant outlet of the radiator 12 are connected by a second passage 17. A water pump 18 is provided on a path of the second passage 17.

The cooling device 10 is provided with a branched passage 20, which is a passage branched from the first passage 16 and connected to the second passage 17 between the coolant outlet of the radiator 12 and the water pump 18. A thermostat 25 is arranged at a connecting portion between the branched passage 20 and the second passage 17. The thermostat 25 is a control valve in which the opening degree of a valve body provided inside varies according to the coolant temperature. When the coolant temperature is low, the coolant flowing out from the water jacket 15W is recirculated by flowing through the branched passage 20 instead of the radiator 12. On the other hand, when the coolant temperature is high, the coolant flowing out of the water jacket 15W is recirculated by flowing through the radiator 12 instead of the branched passage 20.

The control device 100 performs various controls, including controls for an amount of intake air and an amount of injected fuel of the internal combustion engine 15. The control device 100 includes a central processing unit (hereinafter referred to as a CPU) 110, a memory 120 in which control programs and data are stored, a communication device 130, and the like. The control device 100 performs various controls by executing the program stored in the memory 120 by the CPU 110. Further, the control device 100 is capable of establishing communication with a data analysis device 300 via an external network 200 by the communication device 130. In the present embodiment, a first execution unit is configured by the control device 100 including the CPU 110 and the memory 120.

The control device 100 refers to various detected values obtained from, for example, a sensor when performing various controls. For example, the control device 100 refers to a coolant temperature THW, which is the coolant temperature detected by a temperature sensor 34, and outside air temperature THₒᵤₜ detected by an outside air temperature sensor 35.

The data analysis device 300 analyzes data transmitted from a plurality of vehicles 500, a vehicle 600, and the like. The data analysis device 300 includes a CPU 310, a memory 320, a communication device 330, and the like, and these are capable of establishing communication with each other via a network 200. In the present embodiment, a second execution unit is configured by the data analysis device 300 including the CPU 310 and the memory 320.

Calculation of Coolant Deterioration Level

The coolant of the internal combustion engine 15 deteriorates due to oxidation depending on heat receiving temperature and heat receiving time. As the deterioration progresses in this way, the effect of additives such as rust inhibitors decreases. Therefore, in the present embodiment, a deterioration level R of the coolant is calculated.

In the present embodiment, the deterioration level R indicates that the larger its numerical value is, the more the coolant deteriorates. Further, a hydrogen ion concentration (so-called pH) or conductivity of the coolant is used as a physical quantity for determining the deterioration level in a test. For example, analysis of residual components of the coolant or investigation of rust status in a recalled cooling device are also carried out for verification in the actual vehicle.

Processes Executed by Control Device 100

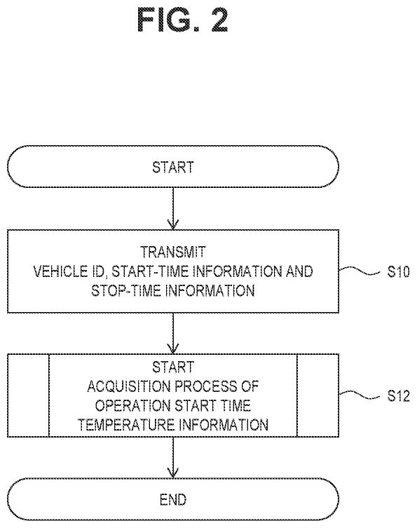

Hereinafter, the calculation of the deterioration level R will be described. FIG. 2 shows a procedure of processes executed by the control device 100. The process shown in FIG. 2 is implemented by executing the program stored in the memory 120 by the CPU 110. The process shown in FIG. 2 is executed when the engine is started.

Hereinbelow, step numbers are represented by a number prefixed with “S”.

When this process is started, the CPU 110 transmits a vehicle ID, which is identification information of the vehicle 500, start-time information, and stop-time information to the data analysis device 300 (S10). The start-time information includes an operation start time coolant temperature THWₛ, i.e. a coolant temperature THW at a time when the control device 100 starts operating when the engine has started, a start time Tₛ at which the control device 100 starts operating, and an operation start time outside air temperature THₒᵤₜₛ, i.e. an outside air temperature THₒᵤₜ at a time when the control device 100 starts operating.

The stop-time information includes a device downtime coolant temperature THWₑ, i.e. a coolant temperature THW at a time when the control device 100 stops operating when the engine has stopped, a device downtime Tₑ at which the control device 100 stops operating, and a device downtime outside air temperature THₒᵤₜₑ, i.e. an outside air temperature THₒᵤₜ at the time when the control device 100 stops operating.

The CPU 110 starts an acquisition process of acquiring operation start time temperature information (S12), and ends the process. The operation start time temperature information is a cumulative time for each temperature as the coolant temperature THW during operation of the internal combustion engine 15, i.e. the control device 100 starts operating.

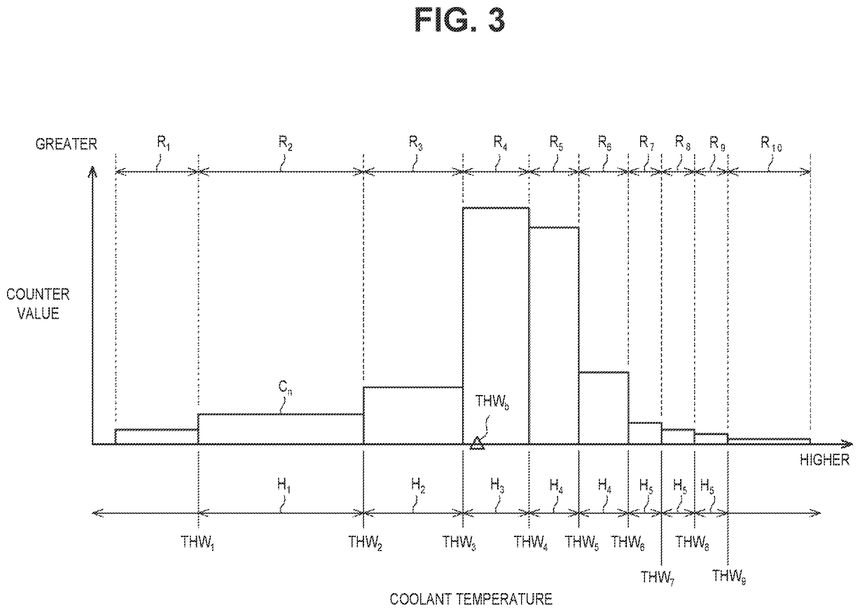

FIG. 3 shows one example of the cumulative time for each temperature as the coolant temperature THW acquired in the acquisition process. In the present embodiment, a plurality of temperature zones are set, and the cumulative time for each temperature as the coolant temperature THW is calculated from a counter value Cₙ indicating the cumulative time for each temperature zone. The counter value Cₙ is a value counted for each temperature zone described below, and the number “n” indicates the corresponding temperature zone. The cumulative time for each temperature zone can be calculated from the counter value Cₙ by multiplying the counter value Cₙ by a sampling cycle of the coolant temperature THW.

More specifically, 10 temperature zones are set as a first temperature zone R₁ a second temperature zone R₂, a third temperature zone R₃, a fourth temperature zone R₄, a fifth temperature zone R₅, a sixth temperature zone R₆, a seventh temperature zone R₇, an eighth temperature zone R₈, a ninth temperature zone R₉, and a tenth temperature zone R₁₀, in order from the lowest temperature zone to the highest temperature zone.

The first temperature zone R₁ is a temperature range lower than a preset first temperature THW₁. The counter value Cₙ of the first temperature zone R₁ is referred to as a first counter value C₁. The second temperature zone R₂ is a temperature range equal to or higher than the first temperature THW₁ and lower than a second temperature THW₂. The second temperature THW₂ is a temperature obtained by adding a preset first temperature width H₁ to the first temperature THW₁. The counter value Cₙ of the second temperature zone R₂ is referred to as a second counter value C₂.

The third temperature zone R₃ is a temperature range equal to or higher than the second temperature THW₂ and lower than a third temperature THW₃. The third temperature THW₃ is a temperature obtained by adding a preset second temperature width H₂ to the second temperature THW₂. The counter value Cₙ of the third temperature zone R₃ is referred to as a third counter value C₃.

The fourth temperature zone R₄ is a temperature range equal to or higher than the third temperature THW₃ and lower than a fourth temperature THW₄. The fourth temperature THW₄ is a temperature obtained by adding a preset third temperature width H₃ to the third temperature THW₃. The counter value Cₙ of the fourth temperature zone R₄ is referred to as a fourth counter value C₄. The fourth temperature zone R₄ is a zone within which a reference temperature THW_{b} (described below) falls.

The fifth temperature zone R₅ is a temperature range equal to or higher than the fourth temperature THW₄ and lower than a fifth temperature THW₅. The fifth temperature THW₅ is a temperature obtained by adding a preset fourth temperature width H₄ to the fourth temperature THW₄. The counter value Cₙ of the fifth temperature zone R₅ is referred to as a fifth counter value C₅.

The sixth temperature zone R₆ is a temperature range equal to or higher than the fifth temperature THW₅ and lower than a sixth temperature THW₆. The sixth temperature THW₆ is a temperature obtained by adding the fourth temperature width H₄ to the fifth temperature THW₅. The counter value Cₙ of the sixth temperature zone R₆ is referred to as a sixth counter value C₆.

The seventh temperature zone R₇ is a temperature range equal to or higher than the sixth temperature THW₆ and lower than a seventh temperature THW₇. The seventh temperature THW₇ is a temperature obtained by adding a preset fifth temperature width H₅ to the sixth temperature THW₆. The counter value Cₙ of the seventh temperature zone R₇ is referred to as a seventh counter value C₇.

The eighth temperature zone R₈ is a temperature range equal to or higher than the seventh temperature THW₇ and lower than an eighth temperature THW₈. The eighth temperature THW₈ is a temperature obtained by adding the fifth temperature width H₅ to the seventh temperature THW₇. The counter value Cₙ of the eighth temperature zone R₈ is referred to as an eighth counter value C₈.

The ninth temperature zone R₉ is a temperature range equal to or higher than the eighth temperature THW₈ and lower than a ninth temperature THW₉. The ninth temperature THW₉ is a temperature obtained by adding the fifth temperature width H₅ to the eighth temperature THW₈. The counter value Cᵣ, of the ninth temperature zone R₉ is referred to as a ninth counter value C₉.

The tenth temperature zone R₁₀ is a temperature range equal to or higher than the ninth temperature THW₉. The counter value Cₙ of the tenth temperature zone R₁₀ is referred to as a tenth counter value C₁₀. The first temperature width H₁ is wider than the second temperature width H₂, and the second temperature width H₂ is wider than the third temperature width H₃. The third temperature width H₃ is wider than the fourth temperature width H₄, and the fourth temperature width H₄ is wider than the fifth temperature width H₅. Since each temperature width is different as stated above, the temperature range of the higher temperature zone (for example, the seventh temperature zone R₇, the eighth temperature zone R₈, and the ninth temperature zone R₉) is narrower than the temperature range of the lower temperature zone.

Since each temperature width is different as stated above, the temperature range of the temperature zone in which the counter value Cₙ tends to be higher (for example, the fourth temperature zone R₄, the fifth temperature zone R₅, and the sixth temperature zone R₆) is narrower than the temperature range of the temperature zone in which the counter value Cₙ tends to be lower.

When a process of S12 is started, the CPU 110 acquires the coolant temperature THW at each predetermined sampling cycle. A process of increasing the counter value Cₙ of the temperature zone within which the acquired coolant temperature THW falls by a predetermined value a (for example, 1) is repeatedly executed while the control device 100 is operating. Consequently, the counter value Cₙ corresponding to the cumulative time for each temperature as the coolant temperature THW is updated for each temperature zone. Each updated counter value Cₙ is stored in the memory 120.

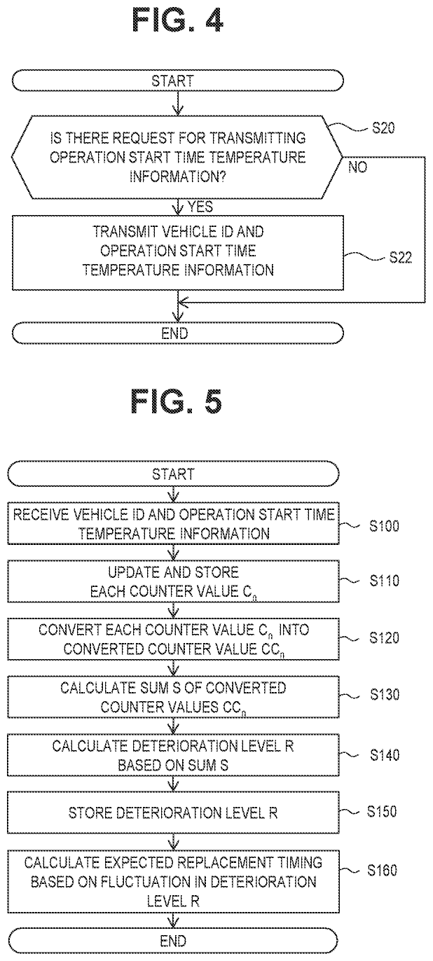

FIG. 4 shows a procedure of processes executed by the control device 100 at predetermined intervals. When this process is started, the CPU 110 determines whether or not there is a request for transmitting the operation start time temperature information (S20). For example, the CPU 110 determines that there is a request for transmitting the operation start time temperature information in a case where a predetermined period has elapsed since the last transmission of the operation start time temperature information. The predetermined period includes the start time of the control device 100, the travel distance of the vehicle 500, and the like.

In a case where it is determined that there is a request for transmitting the operation start time temperature information (S20: YES), the CPU 110 transmits the vehicle ID, which is the identification information of the vehicle 500, and the counter value Cₙ for each temperature zone constituting the operation start time temperature information to the data analysis device 300 (S22). In a case where the process of S22 is completed or NO is determined in the process of S20, the CPU 110 temporarily ends the series of processes shown in FIG. 4.

Processes Executed by Data Analysis Device 300

FIG. 5 shows a procedure of processes executed by the CPU 310 when the data analysis device 300 receives the data transmitted in the process of S22 shown in FIG. 4.

Upon receiving the vehicle ID and the counter value Cₙ (operation start time temperature information) transmitted from the control device 100 in S100, the CPU 310 updates each counter value Cₙ for each temperature zone, stored in the memory 320 in association with the vehicle ID, and thereby stores the updated counter value Cₙ in the memory 320 (S110). The update of the counter value Cₙ is performed by adding the received counter value Cₙ to each counter value Cₙ for each temperature zone stored in the memory 320. As updated, a value of each counter value Cₙ for each temperature zone stored in the memory 320 becomes an integrated value of the counter values Cₙ for each temperature zone which have been received.

The CPU 310 executes a conversion process of converting each updated counter value Cn into a converted counter value CCₙ (S120). The converted counter value CCₙ is a converted value obtained by converting each of the counter values Cₙ for each temperature zone into the counter value Cₙ corresponding to the cumulative time at the predetermined reference temperature THW_{b} (for example, about 90° C.). That is, the converted counter value CCₙ is a value obtained by converting the counter value Cₙ for each temperature zone into the counter value assuming that the coolant temperature THW is the reference temperature THW_{b}. In other words, when the deterioration level corresponding to the counter value Cₙ for each temperature zone is set to a deterioration level Rₙ, the counter value Cₙ required to reach the deterioration level Rₙ at the reference temperature THW_{b} is the converted counter value CCₙ. The number “n” in the converted counter value CCₙ is the same as the number “n” in the counter value Cₙ, which is a conversion source, and indicates the corresponding temperature zone.

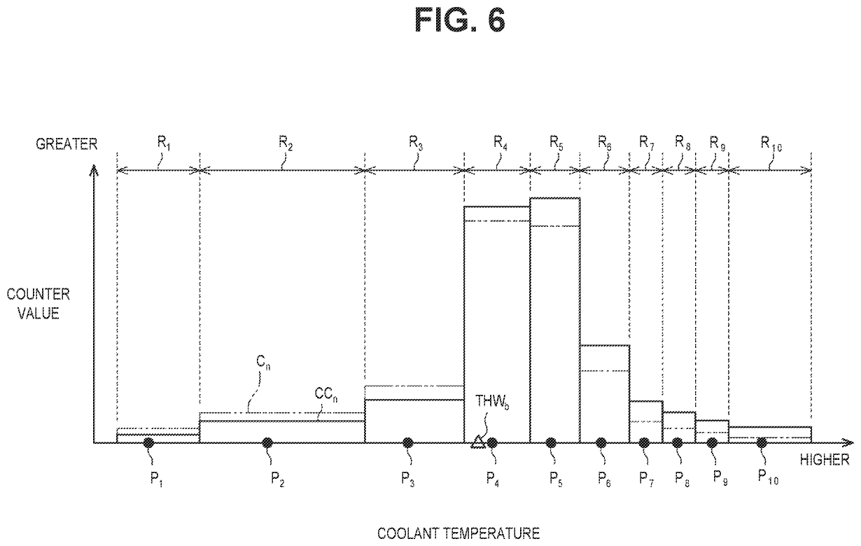

This conversion process is performed as follows. As shown in FIG. 6, a first representative temperature P₁, a second representative temperature P₂, a third representative temperature P₃, a fourth representative temperature P₄, a fifth representative temperature P₅, a sixth representative temperature P₆, a seventh representative temperature P₇, an eighth representative temperature P₈, a ninth representative temperature P₉, and a tenth representative temperature P₁₀ are acquired in advance, each of which is a representative temperature for the respective temperature zones from the first temperature zone R₁ to the tenth temperature zone R₁₀. Hereinbelow, these representative temperatures are collectively referred to as a representative temperature Pₙ. A number indicating the temperature zone is substituted for “n”.

The second representative temperature P₂ to the ninth representative temperature P₉ are obtained from the following equation (1). Any value from 2 to 9 is substituted for “n” in the equation (1). Further, a coefficient K is a value larger than “0” and smaller than “1”, for which an optimum value is set in advance for reducing the error of the deterioration level R.

Pₙ=THW₍ₙ₋₁₎+(THWₙ−THW₍ₙ₋₁₎)×coefficient K (1)

As an example, when the coefficient K is “0.4”, the second representative temperature P₂, which is the representative temperature of the second temperature zone R₂, is obtained from “first temperature THW₁+(second temperature THW₂−first temperature THW₁)×0.4”.

Further, the first representative temperature P₁ and the tenth representative temperature P₁₀ are preset as optimum temperatures for reducing the error of the deterioration level R. The lower the coolant temperature THW is, the less likely it is that the coolant will deteriorate. As shown in FIG. 6, in the temperature zone where the representative temperature Pₙ is lower than the reference temperature THW_{b}, the counter value Cₙ is converted such that the converted counter value CCₙ (shown by a solid line) is smaller than the counter value Cₙ before conversion (shown by a two-dot chain line). The higher the coolant temperature THW is, the easier the coolant deteriorates. As shown in FIG. 6, in the temperature zone where the representative temperature Pₙ is higher than the reference temperature THW_{b}, the counter value Cₙ is converted such that the converted counter value CCₙ (shown by a solid line) is greater than the counter value Cₙ before conversion (shown by a two-dot chain line).

The calculation of the converted counter value CCₙ for each temperature zone is performed using a regression equation in which the representative temperature Pₙ acquired for each temperature zone and the counter value Cₙ of the temperature zone within which the representative temperature Pₙ falls are inputs, and the converted counter value CCₙ is output.

The CPU 310 calculates the sum S by adding all converted counter values CCₙ calculated for the respective temperature zones (S130). The CPU 310 executes a calculation process for calculating the deterioration level R based on the calculated sum S (S140). A relational expression between the sum S and the deterioration level R is obtained in advance, and the CPU 310 calculates the deterioration level R based on such a relational expression. The deterioration level R is calculated such that the deterioration level R increases as the sum S increases. When the deterioration level R is calculated as stated above, the CPU 310 stores the calculated deterioration level R in the memory 320 (S150).

The CPU 310 executes a process of calculating expected replacement timing of the coolant based on a change in the deterioration level R (S160). In S160, the CPU 310 performs the following process, for example. The CPU 310 calculates a time and a travel distance by which the deterioration level R reaches the allowable limit value, based on a difference between the deterioration level R calculated a previous time and the deterioration level R calculated this time, and an elapsed period from the previous calculation of the deterioration level R to the current calculation of the deterioration level R (for example, elapsed time or travel distance). The calculated time and travel distance are set as the expected replacement timing. When the process of S160 is completed, the CPU 310 ends the present process.

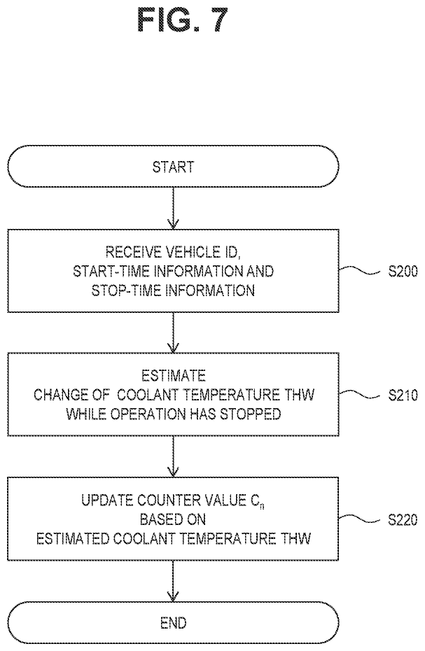

FIG. 7 shows a procedure of processes executed by the CPU 310 when the data analysis device 300 receives the data transmitted in the process of S10 shown in FIG. 2. Upon receiving the vehicle ID, the start-time information, and the stop-time information, transmitted from the control device 100 in S200, the CPU 310 calculates a stop time Tₛₚ, which is a time during which the control device 100 has stopped operating, by subtracting the start time Tₛ included in the start-time information from the device downtime Tₑ included in the stop-time information. The CPU 310 executes an estimation process of estimating change of the coolant temperature THW while the control device 100 has stopped operating, i.e. the coolant temperature THW at each predetermined elapsed time from a time at which the control device 100 stops operating, based on a model formula in which the stop time Tₛₚ, the operation start time coolant temperature THWₛ and the operation start time outside air temperature THₒᵤₜₛ (included in the start-time information), and the device downtime coolant temperature THWₑ and the device downtime outside air temperature THₒᵤₜₑ (included in the stop-time information) are inputs (S210).

The CPU 310 executes an update process of updating each counter value Cₙ, which is stored in the memory 320 in association with the vehicle ID and the counter value Cₙ of the temperature zone within which each coolant temperature THW at the elapsed time, estimated in the process of S210, falls.

The CPU 310 executes an update process of updating the counter value Cₙ for each temperature zone stored in the memory 320 in association with the vehicle ID, based on the coolant temperature THW at each elapsed time estimated in the process of S210 (S220). This process is then terminated.

Operation and Effect

The operation and effect of the present embodiment will be described hereinbelow.

(1) The longer the cumulative time for each coolant temperature THW is, the more the coolant deteriorates. In a case where the cumulative time is the same but the coolant temperature THW is higher, the coolant deteriorates more as compared with a case where the coolant temperature is lower.

For calculating the deterioration level of the coolant, it is necessary to take account of the coolant temperature THW and the cumulative time for each temperature zone. In the present embodiment, the process of converting each of the counter values Cₙ corresponding to the cumulative time acquired for each temperature zone into the counter value Cₙ corresponding to the cumulative time at the reference temperature THW_{b}, i.e. the converted counter value CCₙ, is executed. Therefore, the counter value Cₙ for each temperature zone is converted into the counter value Cₙ assuming that the coolant temperature THW is the reference temperature THW_{b}. Since the deterioration level R is calculated based on the sum S of the converted counter values CCₙ, i.e. the converted counter values Cₙ, the deterioration level R is calculated using the coolant temperature THW and the cumulative time for each temperature zone. Consequently, the deterioration level R of the coolant can be calculated accurately.

(2) Because the coolant temperature remains high for a while even though the internal combustion engine 15 has stopped, the coolant keeps deteriorating even while the internal combustion engine 15 has stopped. In a case where the control device 100 stops operating due to the engine stopping, the temperature change of the coolant during the stop cannot be recognized. In the present embodiment, the change of the coolant temperature THW while the control device 100 has stopped operating can be estimated by the estimation process of the coolant temperature THW as stated above. The counter value Cₙ for each temperature zone is updated based on the coolant temperature THW while the control device 100 has stopped operating. Consequently, the deterioration level R is calculated using the coolant temperature THW while the control device 100 has stopped operating, and thus the estimation accuracy of the deterioration level R is further improved.

(3) Upon sampling of the coolant temperature THW, the plurality of temperature zones are set, and thus it is possible to reduce a calculation load of the control device 100 as compared with a case where such temperature zones are not set. The temperature range of the higher temperature zone is narrower than the temperature range of the lower temperature zone. Since the temperature range of the temperature zone on the high temperature side, which has a great influence on the deterioration level R, is narrow and the temperature zone has the enhanced resolution, it is possible to reduce an estimation error of the deterioration level R caused by dividing the temperature range.

(4) The temperature range of the temperature zone in which the counter value Cₙ tends to be higher is narrower than the temperature range of the temperature zone in which the counter value Cₙ tends to be lower. As described above, the temperature zone in which the counter value Cₙ tends to be higher and the deterioration level R is greatly influenced has the narrower temperature range and the enhanced resolution. Therefore, it is also possible to reduce an estimation error of the deterioration level R caused by dividing the temperature range.

### MODIFIED EXAMPLE

The present embodiment can be modified and implemented as follows. The present embodiment and the following modified examples can be implemented in combination with each other without departing from the technical scope.
The number of temperature zones for the coolant temperature THW and the temperature width may be appropriately changed.
The counter value Cₙ may be obtained for each sampled coolant temperature THW without setting the temperature zones.
The timing at which the operation start time temperature information is transmitted may be changed as appropriate.
The process of S160 shown in FIG. 5 may be omitted.
The series of processes shown in FIG. 7 may be omitted. Even in this case, the operation and effect can be obtained except for the outcome stated in (2).
The change of the coolant temperature THW while the control device 100 has stopped operating may be estimated by another aspect.
Although the temperature ranges of the higher temperature zone and the temperature zone in which the counter value Cₙ tends to be higher are narrowed, the temperature range of either one may be narrowed.
The actual cumulative time may be calculated instead of the counter value Cₙ.
The conversion process of S120 shown in FIG. 7 may be executed by the control device 100. The converted counter value CCₙ may be transmitted instead of the counter value Cₙ as the operation start time temperature information sent to the data analysis device 300.
The series of processes shown in FIG. 7 may be executed by the control device 100.
All the processes stated above may be executed by the control device 100.
The coolant temperature THW acquired while the control device 100 is operating may be transmitted to the data analysis device 300 in real time. The counter value Cₙ may be updated by the data analysis device 300.
The execution unit is not limited to one that is provided with the CPU and the memory to execute the software process. For example, a dedicated hardware circuit (for example, ASIC) that processes at least a part of the software processes executed in each embodiment may be provided. That is, the execution unit may have any of the following configurations (a) to (c). (a) A processing device that executes all processes stated above according to a program, and a program storage device such as a memory that stores the program, are provided. (b) A processing device and a program storage device that execute a part of the processes stated above according to a program, and a dedicated hardware circuit that executes the remaining processes, are provided. (c) A dedicated hardware circuit for executing all processes stated above is provided. There may be a plurality of the software processing circuits having a processing device and a program storage device, or a plurality of the dedicated hardware circuits. That is, the process may be executed by a processing circuit including at least one of the software processing circuits and the dedicated hardware circuits.

What is claimed is:

1. A coolant deterioration level calculation system that calculates a deterioration level of coolant used for an internal combustion engine, the coolant deterioration level calculation system comprising:
an execution unit, wherein the execution unit is configured to execute:
acquisition processing of acquiring a cumulative time for each temperature of the coolant;
conversion processing of converting cumulative times into converted values, respectively, the converted value being a cumulative time at a predetermined reference temperature; and
calculation processing of calculating the deterioration level based on a sum of the converted values.

2. The coolant deterioration level calculation system according to claim 1, wherein, in the acquisition processing, when a temperature of the cumulative time is lower than the reference temperature, the cumulative time is converted such that the converted value is smaller than the cumulative time before conversion.

3. The coolant deterioration level calculation system according to claim 1, wherein, in the acquisition processing, when a temperature of the cumulative time is higher than the reference temperature, the cumulative time is converted such that the converted value is greater than the cumulative time before conversion.

4. The coolant deterioration level calculation system according to claim 1, wherein the execution unit is configured to execute:
estimation processing of estimating a temperature change of the coolant while the execution unit has stopped operating, based on stop-time information including a temperature of the coolant at the time when the execution unit stops operating while the engine has stopped, start-time information including a temperature of the coolant at the time when the execution unit starts operating while the engine has started, and a stop time during which the execution unit has stopped operating; and
update processing of updating the cumulative time for each temperature based on the estimated temperature of the coolant while the execution unit has stopped operating.

5. The coolant deterioration level calculation system according to claim 1, wherein:
a plurality of temperature zones are set;
the cumulative time for each temperature of the coolant is a cumulative time for each of the temperature zones; and
a temperature range of a higher temperature zone is narrower than a temperature range of a lower temperature zone.

6. The coolant deterioration level calculation system according to claim 1, wherein:
a plurality of temperature zones are set;
the cumulative time for each temperature of the coolant is a cumulative time for each of the temperature zones; and
a temperature range of the temperature zone in which the cumulative time tends to be longer is narrower than a temperature range of the temperature zone in which the cumulative time tends to be shorter.
